(19) United States
(12) Patent Application Publication
(10) Pub. No.: US 2023/0362861 A1
(43) Pub. Date: Nov. 9, 2023

(54) METHOD AND APPARATUS FOR SUPPORTING PRIORITY OF NETWORK SLICE IN WIRELESS COMMUNICATION SYSTEM

(71) Applicant: Samsung Electronics Co., Ltd., Gyeonggi-do (KR)

(72) Inventor: Dongeun SUH, Gyeonggi-do (KR)

(21) Appl. No.: 18/143,196

(22) Filed: May 4, 2023

(30) Foreign Application Priority Data
May 4, 2022 (KR) 10-2022-0055625
Jul. 12, 2022 (KR) 10-2022-0085798

(51) Int. Cl. H04W 60/00

(52) U.S. Cl. CPC H04W 60/00

(57) ABSTRACT

The disclosure relates to a 5G or 6G communication system for supporting a higher data transmission rate. A method performed by an access and mobility management function (AMF) entity in a wireless communication system includes receiving, from a UE, a registration request message comprising a network slice access stratum (AS) group (NSAG) information request, receiving, from another entity, NSAG information including single-network slice selection assistance information (S-NSSAI) priority information and mapping information between the S-NSSAI and an NSAG identity, transmitting, to a policy control function (PCF) entity, at least one of the NSAG information or NSAG tracking area (TA) boundary information, receiving, from the PCF entity, NSAG priority information based on the NSAG information, and transmitting, to the UE, a registration response message including at least one of the NSAG information, the NSAG TA boundary information, or the NSAG priority information.

### CROSS-REFERENCE TO RELATED APPLICATIONS

This application is based on and claims priority under 35 U.S.C. § 119 to Korean Patent Application Nos. 10-2022-0055625 and 10-2022-0085798, filed on May 4, 2022, and Jul. 12, 2022, respectively, in the Korean Intellectual Property Office, the entire disclosure of each of which is herein incorporated by reference.

### BACKGROUND

### 1. Field

The disclosure relates generally to a wireless communication system, and more particularly, to a method and apparatus for supporting a network slice group and priority in a wireless communication system.

### 2. Description of Related Art

Fifth generation (5G) mobile communication technologies define broad frequency bands that enable high transmission rates and new services, and can be implemented not only in Sub s 6 gigahertz (GHz) bands such as 3.5 GHz, but also in Above 6 GHz bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

Since 5G mobile communication technology development began, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, L2 pre-processing, and network slicing for providing a dedicated network specialized to a particular service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI \ from the design stage and internalizing end-to-end AI support functions, and next-generation distributed computing technology for implementing services at levels of complexity exceeding the limit of UE operation capability by utilizing ultra-high-performance communication and computing resources.

In the third generation partnership project (3GPP) 5G system, network slice group priority and mapping information between network slices and network slice groups are provided such that a UE performs slice-based cell reselection. When tracking areas (TAs) using different mapping rules exist, mapping information between network slices and network slice groups needs to be separately provided in the TAs using different mapping rules so as to enable cell reselection by the UE in the TAs using different mapping rules. However, since it is inefficient to provide mapping information between network slices and network slice groups with respect to TAs using different mapping rules, it is necessary to determine when mapping information between network slices and network slice groups needs to be provided.

The network slice priority needs to be determined in consideration of policy information on a network slice for the existing UE. The prior art currently provides no method to do so, however.

As such, there is a need in the art for a method and apparatus to enable a home network operator to be allowed to control network slice priorities for cell reselection according to each subscriber even in a roaming situation.

### SUMMARY

Accordingly, the present disclosure provides embodiments that are designed to address at least the problems and/or disadvantages described above and to provide at least the advantages described below.

An aspect of the disclosure is to provide an apparatus and method enabling a network operator to control network slice priorities for cell reselection of each subscriber during roaming in a wireless communication system.

Another aspect of the disclosure is to provide a method and apparatus for determining network slice priority based on network slice policy information for the existing UE.

In accordance with an aspect of the disclosure, a method performed by an access and mobility management function (AMF) entity in a wireless communication system includes receiving, from a UE, a registration request message comprising a network slice access stratum (AS) group (NSAG) information request, receiving, from another entity, NSAG information including single-network slice selection assistance information (S-NSSAI) priority information and mapping information between the S-NSSAI and an NSAG identity, transmitting, to a policy control function (PCF) entity, at least one of the NSAG information or NSAG tracking area (TA) boundary information, receiving, from the PCF entity, NSAG priority information based on the NSAG information, and transmitting, to the UE, a registration response message including at least one of the NSAG information, the NSAG TA boundary information, or the NSAG priority information. In accordance with an aspect of the disclosure, a method performed by a UE in a wireless communication system includes transmitting, to the AMF entity, a registration request message comprising an NSAG information request, and receiving, from the AMF entity, a registration response message including at least one of NSAG information, NSAG TA boundary information, or NSAG priority information, wherein the NSAG information is associated with S-NSSAI priority information and mapping information between the S-NSSAI and an NSAG identity transmitted from another entity, and wherein the NSAG priority information is associated with the NSAG information transmitted from a PCF entity.

In accordance with an aspect of the disclosure, an AMF entity in a wireless communication system includes a transceiver, and at least one processor coupled with the transceiver and configured to receive, from a UE, a registration request message comprising an NSAG information request, receive, from another entity, NSAG information including S-NSSAI priority information and mapping information between the S-NSSAI and an NSAG identity, transmit, to a PCF entity, at least one of the NSAG information or NSAG TA boundary information, receive, from the PCF entity, NSAG priority information based on the NSAG information, and transmit, to the UE, a registration response message including at least one of the NSAG information, the NSAG TA boundary information, or the NSAG priority information.

In accordance with an aspect of the disclosure, a UE in a wireless communication system includes a transceiver, and at least one processor coupled with the transceiver and configured to transmit, to an AMF entity, a registration request message comprising an NSAG information request, and receive, from the AMF entity, a registration response message including at least one of NSAG information, NSAG TA boundary information, or NSAG priority information, wherein the NSAG information is associated with S-NSSAI priority information and mapping information between the S-NSSAI and an NSAG identity transmitted from another entity, and wherein the NSAG priority information is associated with the NSAG information transmitted from a PCF entity.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method for providing network slice access stratum (AS) group (NSAG) information in a UE registration procedure in a wireless communication system according to an embodiment;

FIG. 2 illustrates a method for determining slice priority or slice group priority via unified data management (UDM) in a UE registration procedure in a wireless communication system according to an embodiment;

FIG. 3 illustrates a structure of a UE according to an embodiment;

FIG. 4 illustrates a structure of a RAN according to an embodiment; and

FIG. 5 illustrates a structure of a network entity according to an embodiment.

### DETAILED DESCRIPTION

Hereinafter, the disclosure will be described in detail with reference to the accompanying drawings. A detailed description of known functions or configurations incorporated herein will be omitted when it is determined that the description may make the subject matter of the disclosure unnecessarily unclear. The terms which will be described below are defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. The size of each element does not completely reflect the actual size. In the drawings, identical or corresponding elements are provided with identical reference numerals.

The disclosure is not limited to the embodiments set forth below, but may be implemented in various alternate forms. The embodiments are provided to inform those skilled in the art of the scope of the disclosure. Throughout the specification, the same or like reference numerals designate the same or like elements.

In the disclosure, an element is expressed in the singular or the plural according to embodiments. However, the singular form or plural form is selected appropriately to the presented situation for the convenience of description, and the disclosure is not limited by elements expressed in the singular or the plural form. Therefore, either an element expressed in the plural form may also include a single element or an element expressed in the singular may also include multiple elements.

As used herein, the unit refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided into more elements, or a unit. The elements and units or may be implemented to reproduce one or more central processing units (CPUs) within a device or a security multimedia card. The unit in the embodiments may include one or more processors.

In the following description, terms for identifying access nodes, and terms referring to network entities, messages, interfaces between network entities, and various identification information, are illustratively used for the sake of convenience. Therefore, the disclosure is not limited by the terms as used below, and other terms referring to subjects having equivalent technical meanings may be used.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on a hardware approach. However, embodiments of the disclosure include a technology that uses both hardware and software, and thus may not exclude the perspective of software.

In the following description, the disclosure will be described using terms and names defined in long term evolution (LTE) and NR standards, which are the latest standards specified by 3GPP among the existing communication standards, for the convenience of description. However, the disclosure is not limited thereto and may be applied in the same manner as systems that conform to other standards. In particular, the disclosure may be applied to the 3GPP NR standard and to other communication systems having similar technical backgrounds or channel types. The disclosure may also be applied to other communication systems through some modifications without significantly departing from the scope of the disclosure.

In the following description, terms referring to signals, channels, control information, network entities, and device elements are illustratively used for the convenience of description. Therefore, the disclosure is not limited by the terms as used below, and other terms referring to subjects having equivalent technical meanings may be used.

Moreover, embodiments of the disclosure will be described using terms used in some communication standards but the use of these terms is merely an example for the sake of description. Embodiments of the disclosure may also be easily applied to other communication systems through modifications.

The 5G mobile communication network includes a 5G UE (a terminal), a 5G radio access network (RAN, a base station, 5G NodeB (gNB), evolved NodeB (eNB), etc.), and a 5G core network. The 5G core network includes network functions including an access and mobility management function (AMF) that provides mobility management of a UE, a session management function (SMF) that provides session management, a user plane function (UPF) that performs data transmission, a policy control function (PCF) that provides policy control, UDM that provides a function of managing subscriber data, policy control data, and the like, a unified data repository (UDR) that stores data of various network functions, such as UDM, and the like.

In the 5G system, a network slicing technology represents a technology and structure that enables multiple virtualized and independent logical networks on one physical network. A network operator provides services by configuring a virtual end-to-end network referred to as a network slice in order to satisfy specific requirements of services/applications. The network slice is distinguished by an identifier referred to as single-network slice selection assistance information (S-NSSAI). The network transmits a set of slices (e.g., allowed NSSAI(s)) allowed to a UE in a UE registration procedure, and the UE transmits and receives application data via a protocol data unit (PDU) session generated via one S-NSSAI (i.e., a network slice) among the set of slices.

In the 5G system, the RAN is in charge of one or more TAs, which refer to a unit defined to track the location of a UE in the 5G system, and different frequencies and network slices may be supported by each TA or each cell within the TA. The RAN may broadcast network slice information supported by each TA to the UE, and the UE may identify network slice supported by each TA, based on the network slice information supported by each TA. In this case, the slice information for each TA and each cell broadcast by the RAN may include identifier (i.e., a slice group ID) information on a slice group to which the S-NSSAI for each slice is mapped, instead of the S-NSSAI for each slice. The UE may identify slice groups supported by cells in a TA for each TA, and may identify S-NSSAIs supported by TAs, respectively, based on mapping relationship information between the slice group id and S-NSSAI, received from the AMF via non-access stratum (NAS). The NAS may be a communication protocol between the UE and the AMF and the UE may identify S-NSSAIs supported by cells in a TA for each TA, based on mapping relationship information between the S-NSSAI and the slice group ID.

In a cell reselection process, which is a procedure for selecting a more suitable cell, the UE may determine a cell, based on the S-NSSAI received from the NAS or the priority value for each slice group ID. In addition, the UE may determine a cell, based on slice-related information broadcast by the RAN. For example, when a network operator wants to move a UE to a cell in which a specific slice is supported, a high priority may be given to a slice or slice group related to a cell in which a specific slice is supported.

In the 5G RAN, mapping between slice group ID and S-NSSAI is configured in units of TAs. Accordingly, a different mapping rule between slice group ID and S-NSSAI may be applied to each TA. For example, the same slice group ID may be used to indicate different S-NSSAIs in different TAs. A UE may receive mapping relationship information between S-NSSAI and slice group ID for some TAs belonging to a registration area (RA) from the AMF via the NAS during a network registration procedure. When there are TAs using different mapping rules with respect to slices to which mapping is to be provided, the TAs using different mapping rules and the different mapping relationship information in the TAs using the different mapping rules may be transmitted together after being included therein. When the UE has moved to another TA that does not belong to the RA in which reception is performed in the last network registration procedure, the UE may perform the network registration procedure again and receive mapping information between slice group ID and S-NSSAI for the new TA.

When the UE moves to a TA adjacent to an RA having a different mapping rule, and in order to support cell reselection, the UE needs to be allowed to receive mapping information between slice group ID and S-NSSAI for the TA adjacent to the RA having a different mapping rule. The disclosure presents a method for doing so.

Priority of each network slice or network slice group needs to be determined without violating a network operator's policy. In addition, the priority of each network slice or network slice group needs to be considered together with the determination of other policy control information for a network slice. For example, other policy control information for a network slice may be UE route policy (URSP) information including a rule about a network slice to which traffic provided to the UE is to be transmitted. Accordingly, policy control function (PCF), which is a network function (NF) that is located in the network where the UE is located and manages policy information for the network where the UE is located, needs to be able to support the priority verification function for each network slice or slice group. For example, the network where the UE is located may be a serving network.

A home network operator may want to control the priority of each network slice or network slice group for each subscriber. For example, when several subscribers want access to a specific network slice, a higher priority value is given to a subscriber using the higher rate plan to give the subscriber using the higher rate plan priority for using the specific network slice. Accordingly, UDM, which is an NF that is located in the home network of a UE and stores and manages subscriber information for a UE located in the home network, needs to be able to support the function of controlling priority determination for each network slice or slice group of the UE located in the home network. In addition, when the home network operator provides priority information for each network slice or slice group in the home network to a UE roaming in a visited network, priority information for each network slice or slice group in the home network needs to be converted into priority information for each network slice identifier or network slice group identifier supported by the visited network and provided to the UE. The visited network may be a visited network for which a roaming agreement on network slice priority between operators has been made.

In the 3GPP 5G system, in providing network slice group priority and mapping information between network slices and network slice groups for slice-based cell reselection of the UE, the UE is prevented from referring to incorrect mapping information, and the network operator's policy is efficient, thereby enabling the home network operator to control the network slice priority for cell reselection for each subscriber even in a roaming situation.

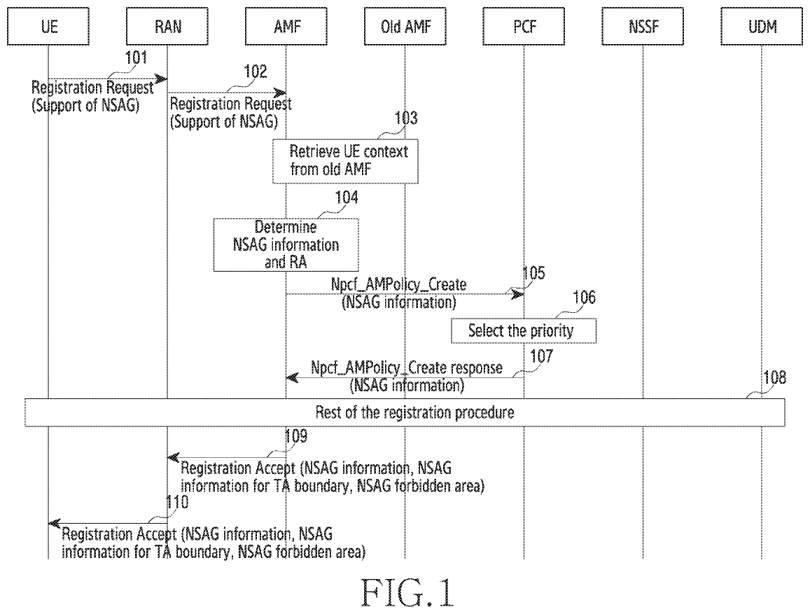

FIG. 1 illustrates a method for providing NSAG information in a UE registration procedure in a wireless communication system according to an embodiment. The NSAG information includes mapping relationship information between a slice group identifier and S-NSSAI for slices and priority information to be used for cell reselection for slices or slice group(s) to which a slice is mapped.

Referring to FIG. 1, in step 101, a UE may transmit an AN message (registration request) to a RAN. The registration request message may include at least one of a UE identifier (a subscription concealed identifier (SUCI), a 5G-globally unique temporary identity (5G-GUTI), a permanent equipment identifier (PEI), etc.), requested NSSAI, UE mobility management (MM) core network capability, and the like. When the UE supports network slice group and network slice priority for cell reselection, the UE may include support of NSAG in the UE MM core network capability.

When a UE supporting NSAG determines that slice group mapping needs to be updated, or when the UE supporting NSAG determines that slice priority needs to be updated, the UE may perform a registration procedure by transmitting a registration request message, and may also include an indication requesting NSAG. A case where the UE determines that slice group mapping needs to be updated may correspond to when a slice group ID which may not be recognized by the UE is received from the RAN. When the AMF receives an indication requesting NSAG, information transmitted to the UE may include NSAG information or information including an indicator instructing the UE to disable slice-based cell reselection.

In step 102, the RAN may select an AMF, based on information in the AN message received from the UE. The RAN may deliver an N2 message (N2 parameters, registration request) to the selected AMF. The N2 parameter may include selected PLMN ID, UE location information, UE context request, and the like. The N2 message may include an RAN ID.

In step 103, operations necessary in the UE registration procedure may be performed. When information indicating support of NSAG is included in the 5GMM core network capability provided by the UE in step 101, the AMF may store the UE's support of NSAG in the UE context information of the UE. When no UE context for the UE exists, the AMF may determine an old AMF of the UE, based on the 5G-GUTI received in step 101 and transmit a UE context request message including an identifier of the UE to the old AMF to receive a UE context of the UE from the old AMF. The received UE context may include one or more of information on whether the UE supports NSAG, priority information on slices or slice groups provided to the UE, and mapping information between slice group id and S-NSSAI.

In step 104, the AMF may determine a registration area (RA), which is for managing mobility of the UE, and allowed NSSAI, which is information on slices allowed within the RA. In addition, the AMF may determine the configured NSSAI, which is information on slices available for the UE in a current network, when the configured NSSAI needs to updated.

In step 104, when the 5GMM core network capability provided by the UE includes information indicating support of NSAG, the AMF may determine NSAG information including mapping information between S-NSSAI and slice group ID with respect to some or all of the slices in configured NSSAI and priority information for each slice or slice group.

The AMF may operate in the following two methods to solve the instance when external TAs adjacent to the RA boundary use different mapping rules between S-NSSAI and slice group ID.

When the AMF identifies that a TA outside the RA and adjacent to the RA boundary uses a different mapping rule between S-NSSAI and slice group ID, the AMF may include, in information to be transmitted to the UE, identifier information of the TA using the different mapping rule between S-NSSAI and slice group ID and mapping relationship information between S-NSSAI and slice group ID with respect to the TA using the different mapping rule between S-NSSAI and slice group ID. The information to be transmitted to the UE may be NSAG information for TA boundary. When AMF does not recognize the mapping relationship information between S-NSSAI and slice group ID for TAs that use different mapping rules between S-NSSAI and slice group ID, the AMF may request the network slice selection function (NSSF) for mapping relationship information between S-NSSAI and slice group ID for TAs that use different mapping rules between S-NSSAI and slice group ID to receive the mapping relationship information and then determine NSAG information for TA boundary.

The RA may be configured such that an external TA adjacent to the RA boundary has the same rule as the mapping rule between S-NSSAI and slice group ID in the RA.

In addition, the AMF may provide information (NSAG forbidden area) on TA(s) in which slice-based cell reselection should not be performed.

In step 105, the AMF may request the PCF to select or verify the NSAG information determined in step 104 and the priority value for the slice or slice group within the NSAG information for the TA boundary. To this end, the AMF may transmit NSAG information and NSAG information for the TA boundary in a request message transmitted to the PCF. The AMF may provide only priority information for each slice, among NSAG information and NSAG information for TA boundary information.

Alternatively, when a new NSAG priority or slice priority for the UE is determined and thus a change occurs in step 104, the AMF may inform the PCF of NSAG priority or slice priority information and UE ID, determined in step 104, via an Npcf_UEPolicyControl Create Request or an Npcf_UEPolicyControl Update Request so that a new NSAG priority or slice priority for the UE may be considered when generating the UE policy for the UE or the UE policy may be updated appropriately in consideration of the new NSAG priority or slice priority for the UE. When the UE is in roaming, the NSAG priority or slice priority information and the UE ID determined in step 104 may be transmitted to the home-PCF (H-PCF) via the visited-PCF (V-PCF). The H-PCF is based on policy control decision functionalities in a home public land mobile network (HPLMN), while the V-PCF is based on policy control decision functionalities in a visited public land mobile network (VPLMN). In step 106, when the message from the AMF in step 105 includes NSAG information, NSAG information for TA boundary or priority information for each slice corresponding to NSAG information, NSAG information for TA boundary, the PCF may select a priority value for each slice or slice group. The PCF may consider a predetermined URSP rule and network operator's policy.

Alternatively, when there is no UE policy yet in case that the Npcf_UEPolicyControl Create Request is received in step 105 and the NSAG priority or slice priority is included in the Npcf_UEPolicyControl Create Request message, the PCF may consider the NSAG priority or slice priority when generating a new UE policy, so as to generate a UE policy. After generating the UE policy, the generated UE policy may be transmitted to the UE via the AMF. The NSAG priority may be priority information for each slice group, and slice priority may be priority information for each slice. The UE policy is to be transmitted to the UE and may include mapping rules between traffic and slices. When the UE is in roaming, the H-PCF may transmit the generated UE policy to the UE via the V-PCF and AMF.

When a UE policy exists in case that the Npcf_UEPolicyControl Update Request message is received in step 105 and the NSAG priority or slice priority is included in the Npcf_UEPolicyControl Update Request message, the PCF may determine whether UE policy update is necessary, based on the received NSAG priority or slice priority. When the PCF determines that UE policy update is necessary, based on the received NSAG priority or slice priority, the PCF may calculate a new UE policy and transmit the updated UE policy to the UE via the AMF. When the UE is in roaming, the H-PCF may transmit the updated UE policy to the UE via the V-PCF and AMF.

In step 107, the PCF may include information on a priority value for each slice or slice group determined in step 106 in a response message the PCF transmits to the AMF.

In step 108, the remaining UE registration procedures may be performed.

In step 109, the AMF may include a registration accept message in an N2 message the AMF transmits to the RAN.

When the AMF determines NSAG information, NSAG information for TA boundary, and NSAG forbidden area in step 104, the AMP may include the NSAG information, NSAG information for TA boundary, and NSAG forbidden area information in the registration accept message to be transmitted to the UE.

In step 110, the RAN may transmit the registration accept message within the message received from the AMF in step 109 to the UE.

When the UE moves to the RA boundary to receive slice group IDs supported by a cell in the TA included in the NSAG information for TA boundary information after the UE receives NSAG information for TA boundary, the UE may recognize slice(s) corresponding to the received slice group ID. For example, when the UE receives slice group IDs, the UE may recognize slice(s) corresponding to the received slice group ID via information included in NSAG information for TA boundary. The UE may perform cell reselection, based on the slice(s) corresponding to the received slice group ID.

When the UE receives an NSAG forbidden area, slice-based cell reselection is not performed in TAs included in the NSAG forbidden area. That is, cell reselection may not be performed in consideration of slice group IDs broadcast in TAs included in the NSAG forbidden area.

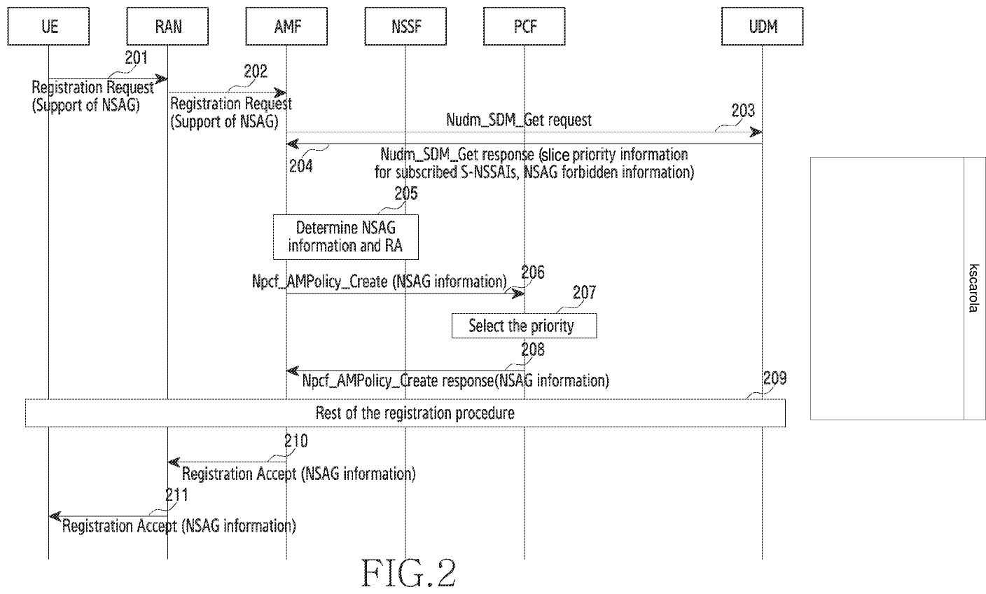

FIG. 2 illustrates a method for determining slice priority or slice group priority via UDM in a UE registration procedure in a wireless communication system according to an embodiment.

Referring to FIG. 2, in step 201, a UE may transmit an AN message (AN parameter, registration request) to a RAN. The registration request message may include at least one of a UE identifier (SUCI, 5G-GUTI, or PEI, etc.), requested NSSAI, UE MM core network capability, and the like. When the UE supports network slice group and network slice priority for cell reselection, the UE may include support of NSAG in the UE MM core network capability.

In step 202, the RAN may select an AMF, based on information in the AN message received from the UE. The RAN may deliver an N2 message (N2 parameters, registration request) to the selected AMF. The N2 parameter may include selected PLMN ID, UE location information, UE context request, and the like. The N2 message may include an RAN ID.

In step 203, the AMF may include an identifier of the UE and identifiers for requested information in an Nudm_SDM_Get request message the AMF transmits to the UDM and request subscriber information of the UE. In this case, when the UE supports NSAG, the AMF may include an identifier requesting slice priority information in the UDM.

In step 204, the UDM may include the UE identifier of the message received from the AMF in step 203 and subscriber information on the requested information in a response message the UDM transmits to the AMF. The response message that transmits the UE identifier of the message received from AMF and subscriber information on the requested information to AMF may include the following information.

Subscribed slice information (subscribed S-NSSAIs), slice priority information for each slice within the subscribed slice (slice priority for subscribed S-NSSAIs) (the priority information may be provided for each slice or slice group), and NSAG forbidden information.

NSAG forbidden information may be one of an indicator for forbidding slice-based cell reselection of a UE, an indicator for forbidding slice-based cell reselection of a UE in roaming, and an indicator for forbidding cell reselection in a specific geographic location.

In step 205, when NSAG forbidden information exists in the information received in step 204 and the NSAG forbidden information indicates an indicator for forbidding slice-based cell reselection of a UE, the AMF may not provide NSAG information to the UE. When the NSAG forbidden information is an indicator for forbidding slice-based cell reselection of the UE in roaming, the AMF may not provide NSAG information to the UE in roaming. When the NSAG forbidden information is an indicator for forbidding slice-based cell reselection in a specific geographic location, the AMF may provide, to the UE, information on a TA in which slice-based cell reselection is prohibited, together with the NSAG information.

When NSAG forbidden information is not included in the information received in step 204, the AMF calculates NSAG information including slice priority information to be provided to the UE for cell reselection, based on the information received from the UDM in step 204.

The AMF may request the NSSF to determine NSAG information, and the message requesting NSSF may include the following information.

Slice priority for subscribed S-NSSAIs received from UDM, subscribed S-NSSAIs, and an NSAG information request indicator indicating that the UE supports NSAG.

When NSAG information request indicator and slice priority for subscribed S-NSSAIs are included in the NSSF, the NSSF determines whether to use slice priority for subscribed S-NSSAIs as it is, based on an operator policy. When the UE is in roaming, the NSSF determines whether to use slice priority for subscribed S-NSSAIs according to an agreement between the home network operator and the visited network operator.

The response message transmitted by the NSSF to the AMF may include,

NSAG information, a configured NSSAI, and mapping of the configured NSSAI.

The NSAG information includes mapping information between slice group ID and S-NSSAI corresponding to slice priority information for each slice or slice group determined by the NSSF. When the UE is in roaming, slice identifiers in NSAG information include slice identifiers of visited networks. Therefore, when the NSSF determines that the UE is in roaming, the NSSF may jointly provide a configured NSSAI and mapping of the configured NSSAI. The mapping of the configured NSSAI indicates a mapping relationship between subscribed S-NSSAIs (i.e., home network identifiers) and slice identifiers (i.e., visited network slice identifiers) included in configured NSSAI.

The AMF may directly calculate NSAG information by using slice priority for subscribed S-NSSAIs and subscribed S-NSSAIs received from the UDM without requesting the NSSF.

In step 206, the AMF may request the PCF to select or verify a priority value for a slice or slice group within the NSAG information determined in step 205. To this end, the AMF may transmit NSAG information in a request message to be transmitted to the PCF. The AMF may provide only priority information for each slice in the NSAG information.

Alternatively, when a new NSAG priority or slice priority for the UE is determined and thus a change occurs in step 205, the AMF may inform the PCF of NSAG priority or slice priority information and a UE ID, determined in step 205, via an Npcf_UEPolicyControl Create Request or an Npcf_UEPolicyControl Update Request so that new NSAG priority or slice priority for the UE may be considered when generating the UE policy for the UE or the UE policy may be updated appropriately in consideration of the new NSAG priority or slice priority for the UE. When the UE is in roaming, the NSAG priority or slice priority information and the UE ID determined in step 205 may be transmitted to the H-PCF via the V-PCF.

In step 207, when the message from the AMF in step 206 includes NSAG information or priority information for each slice, the PCF may select a priority value for each slice or slice group. The PCF may consider a predetermined URSP rule and network operator's policy.

Alternatively, when there is no UE policy yet when the Npcf_UEPolicyControl Create Request is received in step 206 and the NSAG priority or slice priority is included in the Npcf_UEPolicyControl Create Request message, the PCF may consider the NSAG priority or slice priority when generating a new UE policy, so as to generate a UE policy. Slice priority is information for each slice. The UE policy is information to be transmitted to the UE and may include a mapping rules between traffic and slices. When the UE is in roaming, the H-PCF may transmit the generated UE policy to the UE via the V-PCF and AMF.

When a UE policy exists when the Npcf_UEPolicyControl Update Request message is received in step 206 and the NSAG priority or slice priority is included in the Npcf_UEPolicyControl Update Request message, the PCF may determine whether a UE policy update is necessary, based on the received NSAG priority or slice priority. When the PCF determines that the UE policy update is necessary, based on the received NSAG priority or slice priority, the PCF may calculate a new UE policy and transmit the updated UE policy to the UE via the AMF. When the UE is in roaming, the H-PCF may transmit the updated UE policy to the UE via the V-PCF and AMF.

In step 208, the PCF may include information on a priority value for each slice or slice group determined in step 207 in a response message the PCF transmits to the AMF.

In step 209, the remaining UE registration procedures may be performed.

In step 210, the AMF may include a registration accept message in an N2 message the AMF transmits to the RAN. When the AMP determines NSAG information in step 205, the AMP may include the NSAG information in the registration accept message the AMF transmits to the UE. When the AMF determines NSAG information in step 205, the AMF may include NSAG information, configured NSSAI, and mapping of configured NSSAI information in the registration accept message the RAN transmits to the UE.

Specifically, in step 211, the RAN may transmit the registration accept message within the message received from the AMF in step 210 to the UE.

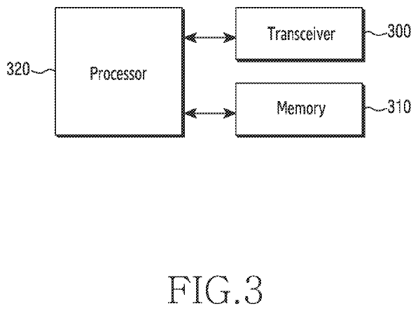

FIG. 3 illustrates a structure of a UE according to an embodiment.

As shown in FIG. 3, the UE may include a processor 320, a transceiver 300, and a memory 310. However, the components of the UE are not limited to the above-described examples. For example, the UE may include more or fewer components than the above-described components. In addition, the processor 320, the transceiver 300, and the memory 310 may be implemented as a single chip.

The processor 320 may control a series of processes which may be performed by the UE according to the above-described embodiment. For example, the processor 320 may control components of a UE to perform a method for supporting priority of a network slice according to the above-described embodiments. The processor 320 may execute a program stored in the memory 310 to control the components of the UE such that the above-described embodiments of the disclosure are performed. In addition, the processor 320 may be an application processor (AP), a communication processor (CP), a circuit, an application-specific circuit, or at least one processor.

The transceiver 300 may transmit/receive a signal to/from a network entity, another UE, or a RAN. A signal transmitted to and received from a network entity, another UE, or a RAN may include control information and data. The transceiver 300 may include an RF transmitter for up-converting and amplifying the frequency of a transmitted signal, an RF receiver for low-noise amplifying and down-converting the frequency of a received signal, and the like. However, the components of the transceiver 300 are not limited to the RF transmitter and the RF receiver. In addition, the transceiver 300 may receive a signal via a wireless channel, output the signal to the processor 320, and transmit the signal output from the processor 320 via the wireless channel.

The memory 310 may store programs and data required for operation of the UE. In addition, the memory 310 may store control information or data included in signals transmitted and received by the UE. The memory 310 may include a storage medium, such as a read only memory (ROM), a random access memory (RAM), a hard disk, a CD-ROM, and a digital versatile disc (DVD), or a combination of storage mediums. In addition, a plurality of memories 310 may be provided, and the memory 310 may store a program for performing a method for supporting priorities of network slices according to the above-described embodiments.

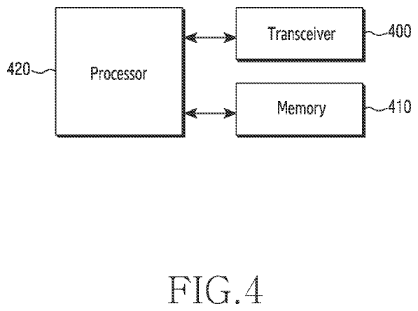

FIG. 4 illustrates a structure of a RAN according to an embodiment.

As shown in FIG. 4, the RAN may include a processor 420, a transceiver 400, and a memory 410. However, components of the RAN are not limited to the above-described examples. For example, a RAN may include more or fewer components than the above-described components. In addition, the processor 420, the transceiver 400, and the memory 410 may be implemented as a single chip.

The processor 420 may control a series of processes which may be performed by the RAN according to the above-described embodiment. For example, the processor 420 may control components of the RAN to perform a method for supporting priority of a network slice according to the above-described embodiments. The processor 420 may execute a program stored in the memory 410 to control the components of the RAN such that the above-described embodiments of the disclosure are performed. In addition, the processor 420 may be at least one processor.

The transceiver 400 may transmit/receive a signal to/from a network entity, another RAN, or a UE. A signal transmitted to and received from a network entity, another RAN, or a UE may include control information and data. The transceiver 400 may include an RF transmitter for up-converting and amplifying the frequency of a transmitted signal, an RF receiver for low-noise amplifying and down-converting the frequency of a received signal, and the like. However, the components of the transceiver 400 are not limited to the RF transmitter and the RF receiver. In addition, the transceiver 400 may receive a signal via a wireless channel, output the signal to the processor 420, and transmit the signal output from the processor 420 via the wireless channel.

The memory 410 may store programs and data required for operation of the RAN and may store control information or data included in signals transmitted and received by the RAN. The memory 410 may include a storage medium, such as a ROM, a RAM, a hard disk, a CD-ROM, and a DVD, or a combination of storage mediums, and a plurality of memories 410 may be provided. In addition, the memory 410 may store a program for performing a method for supporting priorities of network slices according to the above-described embodiments.

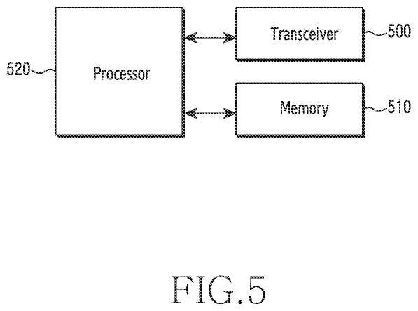

FIG. 5 illustrates a structure of a network entity according to an embodiment.

As shown in FIG. 5, the network entity may include a processor 520, a transceiver 500, and a memory 510. However, components of the network entity are not limited to the above-described examples. For example, the network entity may include more or fewer components than the above-described components. In addition, the processor 520, the transceiver 500, and the memory 510 may be implemented as a single chip.

The processor 520 may control a series of processes which may be performed by the network entity according to the above-described embodiment. For example, the processor 520 may control components of the network entity to perform a method for supporting priority of a network slice according to the above-described embodiments. The processor 520 may execute a program stored in the memory 510 to control the components of the network entity such that the above-described embodiments of the disclosure are performed. In addition, the processor 520 may be at least one processor.

The transceiver 500 may transmit/receive a signal to/from another network entity, a RAN, or a UE. A signal transmitted to and received from another network entity or a UE may include control information and data. The transceiver 500 may include an RF transmitter for up-converting and amplifying the frequency of a transmitted signal, an RF receiver for low-noise amplifying and down-converting the frequency of a received signal, and the like. However, the components of the transceiver 500 are not limited to the RF transmitter and the RF receiver. In addition, the transceiver 500 may receive a signal via a wireless channel, output the signal to the processor 520, and transmit the signal output from the processor 520 via the wireless channel.

The memory 510 may store programs and data required for operation of the network entity. In addition, the memory 510 may store control information or data included in signals transmitted and received by the network entity. The memory 510 may include a storage medium, such as a ROM, a RAM, a hard disk, a CD-ROM, and a DVD, or a combination of storage mediums. A plurality of memories 510 may be provided, and the memory 510 may store a program for performing a method for supporting priorities of network slices according to the above-described embodiments.

As described above, a method performed by an AMF entity in a wireless communication system includes receiving, from a UE, a registration request message comprising an NSAG information request, receiving, from another entity, NSAG information including S-NSSAI priority information and mapping information between S-NSSAI and a NSAG identity, transmitting, to a PCF entity, at least one of the NSAG information or NSAG TA boundary information, receiving, from the PCF entity, NSAG priority information based on the NSAG information, transmitting, to the UE, a registration response message including at least one of the NSAG information, the NSAG TA boundary information, or the NSAG priority information.

According to an embodiment, the another entity including an old AMF entity.

The method further includes receiving, the another entity, the NSAG information comprising: receiving, from a UDM entity, the S-NSSAI priority information, receiving, from or network slice selection function (NSSF) entity, the mapping information between the S-NSSAI and the NSAG identity.

The method further includes wherein the registration response information further comprising NSAG forbidden area information,

The method further includes transmitting, to the PCF entity, a UE policy update request message based on the NSAG priority, receiving, from the PCF entity, a UE policy update response message including an updated UE policy.

As described above, a method performed by a UE in a wireless communication system includes transmitting, to the AMF entity, a registration request message comprising an NSAG information request, receiving, from the AMF entity, a registration response message including at least one of NSAG information, NSAG TA boundary information, or NSAG priority information, wherein the NSAG information is associated with S-NSSAI priority information and mapping information between S-NSSAI and a NSAG identity from another entity, wherein the NSAG priority information is associated with the NSAG information from a PCF entity.

The method further includes the another entity including an old AMF entity.

The method further includes wherein the S-NSSAI priority information is transmitted from a UDM entity, and wherein the mapping information between the S-NSSAI and the NSAG identity is transmitted from the NSSF entity.

The method further includes wherein the registration response information further comprising NSAG forbidden area information,

The method further includes receiving, from the PCF entity, an updated UE policy based on the NSAG priority.

As described above, an AMF entity in a wireless communication system includes a transceiver, and at least one processor coupled with the transceiver and configured to: receive, from a UE, a registration request message comprising an NSAG information request, receive, from another entity, NSAG information including S-NSSAI priority information and mapping information between S-NSSAI and a NSAG identity, transmit, to a PCF entity, at least one of the NSAG information or NSAG TA boundary information, receive, from the PCF entity, NSAG priority information based on the NSAG information, transmit, to the UE, a registration response message including at least one of the NSAG information, the NSAG TA boundary information, or the NSAG priority information.

As described above, a UE in a wireless communication system includes a transceiver, and at least one processor coupled with the transceiver and configured to: transmit, to the AMF entity, a registration request message comprising an NSAG information request, receive, from the AMF entity, a registration response message including at least one of NSAG information, NSAG TA boundary information, or NSAG priority information, wherein the NSAG information is associated with S-NSSAI priority information and mapping information between S-NSSAI and a NSAG identity transmitted from another entity, wherein the NSAG priority information is associated with the NSAG information transmitted from a PCF entity.

As described above, a method performed by a UE may include transmitting a registration request message to a RAN, and receiving a registration accept message including NSAG information related to priority of each network slice from the RAN via an AMF, wherein the registration request message includes NSAG support information, the registration request message is transmitted to the AMF via the RAN, and the NSAG information is determined based on the NSAG support message.

The methods according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to embodiments of the disclosure.

The programs (software modules or software) may be stored in non-volatile memories including a random access memory and a flash memory, a ROM, an electrically erasable programmable read only memory (EEPROM), a magnetic disc storage device, a compact disc-ROM (CD-ROM), DVDs, or other type optical storage devices, or a magnetic cassette. Alternatively, any combination of some or all of the memories may form a memory in which the program is stored. A plurality of such memories may be included in the electronic device.

In addition, the programs may be stored in an attachable storage device which may access the electronic device through communication networks such as the Internet, Intranet, local area network (LAN), Wide LAN (WLAN), and storage area network (SAN) or a combination thereof. Such a storage device may access the electronic device via an external port. A separate storage device on the communication network may access a portable electronic device.

Herein, each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been particularly shown and described with reference to certain embodiments thereof, it will be understood by those skilled in the art that various changes in form and details may be made therein without departing from the scope of the subject matter as defined by the appended claims and their equivalents.

What is claimed is:

1. A method performed by an access and mobility management function (AMF) entity in a wireless communication system, the method comprising:
receiving, from a user equipment (UE), a registration request message comprising a network slice access stratum (AS) group (NSAG) information request;
receiving, from another entity, NSAG information including single-network slice selection assistance information (S-NSSAI) priority information and mapping information between the S-NSSAI and an NSAG identity;
transmitting, to a policy control function (PCF) entity, at least one of the NSAG information or NSAG tracking area (TA) boundary information;
receiving, from the PCF entity, NSAG priority information based on the NSAG information; and
transmitting, to the UE, a registration response message including at least one of the NSAG information, the NSAG TA boundary information, or the NSAG priority information.

2. The method of claim 1, wherein the another entity includes an old AMF entity.

3. The method of claim 1, wherein receiving, from the another entity, the NSAG information comprises:
receiving, from a unified data management (UDM) entity, the S-NSSAI priority information; and
receiving, from a network slice selection function (NSSF) entity, the mapping information between the S-NSSAI and the NSAG identity.

4. The method of claim 1, wherein the registration response message further comprises NSAG forbidden area information.

5. The method of claim 1, further comprising:
transmitting, to the PCF entity, a UE policy update request message based on the NSAG priority; and
receiving, from the PCF entity, a UE policy update response message including an updated UE policy.

6. A method performed by a user equipment (UE) in a wireless communication system, the method comprising:
transmitting, to an access and mobility management function (AMF) entity, a registration request message comprising a network slice access stratum (AS) group (NSAG) information request; and
receiving, from the AMF entity, a registration response message including at least one of NSAG information, NSAG tracking area (TA) boundary information, or NSAG priority information,
wherein the NSAG information is associated with single-network slice selection assistance information (S-NSSAI) priority information and mapping information between the S-NSSAI and an NSAG identity transmitted from another entity, and
wherein the NSAG priority information is associated with the NSAG information transmitted from a policy control function (PCF) entity.

7. The method of claim 6, wherein the another entity includes an old AMF entity.

8. The method of claim 6, wherein the S-NSSAI priority information is transmitted from a unified data management (UDM) entity, and
wherein the mapping information between the S-NSSAI and the NSAG identity is transmitted from a network slice selection function (NSSF) entity.

9. The method of claim 6, wherein the registration response information further comprises NSAG forbidden area information.

10. The method of claim 6, further comprising receiving, from the PCF entity, an updated UE policy based on the NSAG priority.

11. An access and mobility management function (AMF) entity in a wireless communication system, the AMF entity comprising:
a transceiver; and
at least one processor coupled with the transceiver and configured to:
receive, from a user equipment (UE), a registration request message comprising a network slice access stratum (AS) group (NSAG) information request,
receive, from another entity, NSAG information including single-network slice selection assistance information (S-NSSAI) priority information and mapping information between the S-NSSAI and an NSAG identity,
transmit, to a policy control function (PCF) entity, at least one of the NSAG information or NSAG tracking area (TA) boundary information,
receive, from the PCF entity, NSAG priority information based on the NSAG information, and
transmit, to the UE, a registration response message including at least one of the NSAG information, the NSAG TA boundary information, or the NSAG priority information.

12. The AMF entity of claim 11, wherein the another entity includes an old AMF entity.

13. The AMF entity claim 11, wherein, in order to receive the another entity, the at least one processor is further configured to:
receive, from a unified data management (UDM) entity, the S-NSSAI priority information, and
receive, from a network slice selection function (NSSF) entity, the mapping information between the S-NSSAI and the NSAG identity.

14. The AMF entity of claim 11, wherein the registration response information further comprises NSAG forbidden area information.

15. The AMF entity of claim 11, wherein the at least one processor is further configured to:
transmit, to the PCF entity, a UE policy update request message based on the NSAG priority, and
receive, from the PCF entity, a UE policy update response message including an updated UE policy.

16. A user equipment (UE) in a wireless communication system, the UE comprising:
a transceiver; and
at least one processor coupled with the transceiver and configured to:
transmit, to an access and mobility management function (AMF) entity, a registration request message comprising network slice access stratum (AS) group (NSAG) information request, and
receive, from the AMF entity, a registration response message including at least one of NSAG information, NSAG tracking area (TA) boundary information, or NSAG priority information,
wherein the NSAG information is associated with single-network slice selection assistance information (S-NSSAI) priority information and mapping information between the S-NSSAI and an NSAG identity transmitted from another entity, and
wherein the NSAG priority information is associated with the NSAG information transmitted from a policy control function (PCF) entity.

17. The UE of claim 16, wherein the another entity includes an old AMF entity.

18. The UE of claim 16, wherein the S-NSSAI priority information is transmitted from a unified data management (UDM) entity, and
wherein the mapping information between the S-NSSAI and the NSAG identity is transmitted from a network slice selection function (NSSF) entity.

19. The UE of claim 16, wherein the registration response information further comprises NSAG forbidden area information.

20. The UE of claim 16, wherein the at least one processor is further configured to receive, from the PCF entity, an updated UE policy based on the NSAG priority.
